(19) United States
(12) Patent Application Publication
(10) Pub. No.: US 2012/0184276 A1
(43) Pub. Date: Jul. 19, 2012

(54) Method, Apparatus and System for Preventing the Initiation of a Handover for a Time Period After the End of a Service

(76) Inventors: Roman Pichna, Espoo (FI); Ingo Viering, Munchen (DE)

(21) Appl. No.: 13/392,125

(22) PCT Filed: Aug. 27, 2009
(86) PCT No.: PCT/EP2009/061081

§ 371 Date: Mar. 26, 2012

(51) Int. Cl. H04W 36/00

(52) U.S. Cl. 455/436

(57) ABSTRACT

Preventing initiation of a handover of a communication device back to a first radio access technology from a second radio access technology before the expiry of a predetermined length of time after the end of a service provided via the second radio access technology.

The present invention relates to the handover of a communication device between two different radio access technologies. In one embodiment, it relates to handover back to LTE (Long Term Evolution) radio access technology from a 2G/3G radio access technology after the provision of a circuit-switched service via the 2G/3G radio access technology.

A communication device can be understood as a device provided with appropriate communication and control capabilities for enabling use thereof for communication with others parties. The communication may comprise, for example, communication of voice, electronic mail (email), text messages, data, multimedia and so on. A communication device typically enables a user of the device to receive and transmit communication via a communication system and can thus be used for accessing various service applications.

A communication system is a facility which facilitates the communication between two or more entities such as the communication devices, network entities and other nodes. A communication system may be provided by one or more interconnect networks. One or more gateway nodes may be provided for interconnecting various networks of the system. For example, a gateway node is typically provided between an access network and other communication networks, for example a core network and/or a data network.

An appropriate access system allows the communication device to access to the wider communication system. An access to the wider communications system may be provided by means of a fixed line or wireless communication interface, or a combination of these. Communication systems providing wireless access typically enable at least some mobility for the users thereof. Examples of these include wireless communications systems where the access is provided by means of an arrangement of cellular access networks. Other examples of wireless access technologies include different wireless local area networks (WLANs) and satellite based communication systems.

A wireless access system typically operates in accordance with a wireless standard and/or with a set of specifications which set out what the various elements of the system are permitted to do and how that should be achieved. For example, the standard or specification may define if the user, or more precisely user equipment, is provided with a circuit switched bearer or a packet switched bearer, or both. Communication protocols and/or parameters which should be used for the connection are also typically defined. For example, the manner in which communication should be implemented between the user equipment and the elements of the networks and their functions and responsibilities are typically defined by a predefined communication protocol. Such protocols and or parameters further define the frequency spectrum to be used by which part of the communications system, the transmission power to be used etc.

In the cellular systems a network entity in the form of a base station provides a node for communication with mobile devices in one or more cells or sectors. It is noted that in certain systems a base station is called ‘Node B’. Typically the operation of a base station apparatus and other apparatus of an access system required for the communication is controlled by a particular control entity. The control entity is typically interconnected with other control entities of the particular communication network. Examples of cellular access system technologies include in order of their evolvement: GSM (Global System for Mobile) EDGE (Enhanced Data for GSM Evolution) Radio Access Networks (GERAN); Universal Terrestrial Radio Access Networks (UTRAN); and Evolved UTRAN (E-UTRAN).

Where a communication device is capable of operating according to a plurality of radio access technologies (RATs) and is in an area where there is coverage for two or more RATs, it is proposed that the communication device, depending on the operator policy, may be served mainly by the most evolved one of those RATs, but with the possibility to handover to a lesser-evolved one of those RATs in order to facilitate the provision of one or more services.

One aim of the present invention is to provide an efficient technique for switching between radio access technologies.

The present invention provides a technique comprising: preventing initiation of a handover of a communication device back to a first radio access technology from a second radio access technology before the expiry of a predetermined length of time after the end of a service provided via the second radio access technology.

In one embodiment, the predetermined time is determined taking into account information about time gaps between previous handovers from said first access technology to said second handover technology.

In one embodiment, said information is limited to information for said communication device, or is limited to information for a subscriber with which said communication device is associated.

In one embodiment, said information includes information for said communication device and other communication devices.

In one embodiment, said predetermined time is determined further taking into account one or more of the following: (a) the time of the handover from said first access technology to said second access technology; and (b) the type of environment in which the handover from said first access technology to said second access technology takes place.

In one embodiment, said predetermined time is determined further taking into account one or more of the following: (a) a capability category of said communication device; and (b) a class of traffic consumption history to which said communication device belongs.

In one embodiment, said service is a circuit-switched service.

In one embodiment, the technique further comprises: initiating the handover of said communication device back to said first radio access technology from said second radio access technology after the expiry of said predetermined length of time.

In one embodiment, said first radio access technology enables packet-switched services, and said second radio access technology enables both packet-switched services and circuit-switched services.

In one embodiment, the technique further includes receiving an indicator of said predetermined time as part of signalling for a handover from said first access technology to said second access technology prior to said service.

The present invention also provides a technique comprising: as part of the signalling for a handover of a communication device from a first radio access technology to a second radio access technology, providing from an element associated with the first radio access technology to an element associated with the second radio access technology an indicator of a predetermined time after the end of a service provided via said second radio access technology before which handover of said communication device back to the first radio access technology is to be prevented.

The present invention also provides a technique comprising: handing over a communication device from a first radio access technology to a second radio access technology; providing a service to the communication device via the second radio access technology; and preventing initiation of a handover of said communication device back to said first radio access technology from said second radio access technology before the expiry of a predetermined length of time after the end of a service provided via the second radio access technology.

The present invention also provides a system configured to: hand over a communication device from a first radio access technology to a second radio access technology; provide a service to the communication device via the second radio access technology; and prevent initiation of a handover of said communication device back to said first radio access technology from said second radio access technology before the expiry of a predetermined length of time after the end of a service provided via the second radio access technology.

Hereunder an embodiment of the present invention will be described in detail, by way of example only, with reference to the following drawings, in which:

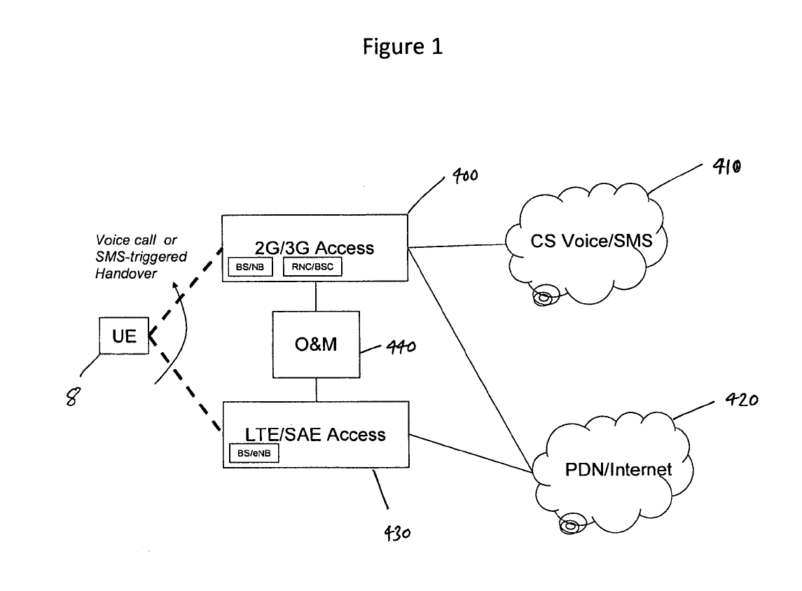

FIG. 1 illustrates the general architecture of a communication system within which an embodiment of the invention may be implemented;

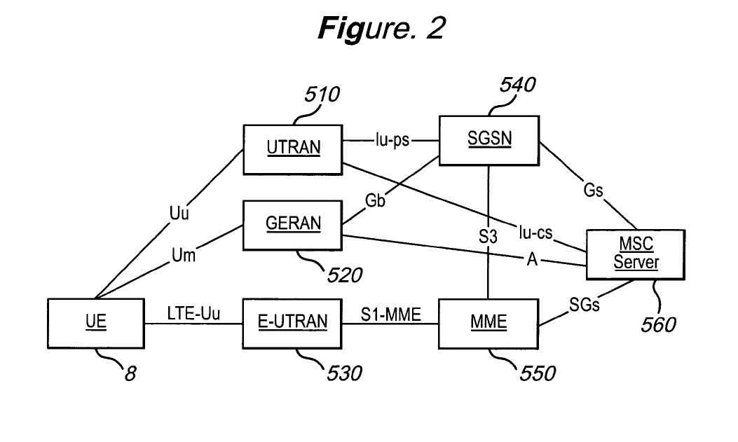

FIG. 2 illustrates in more detail the architecture of a communication system within which an embodiment of the invention may be implemented;

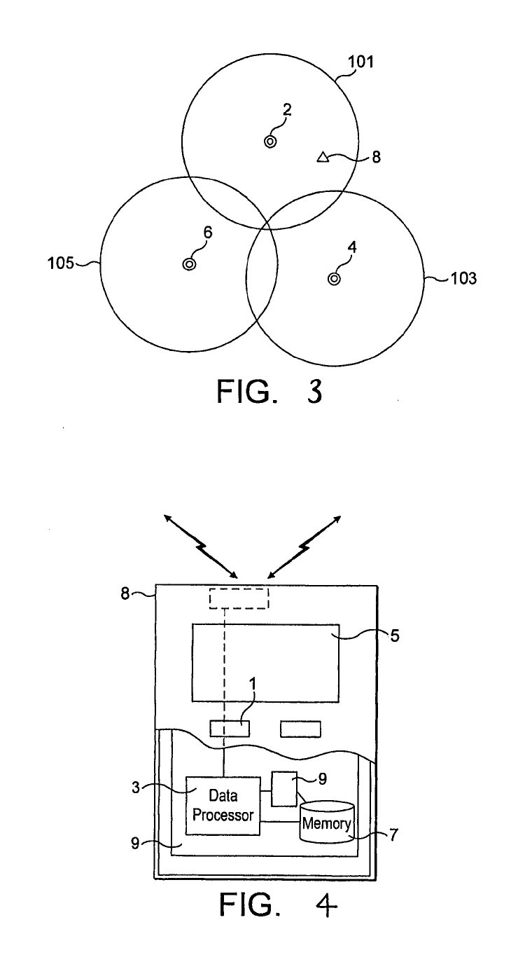

FIG. 3 illustrates the basic structure of a cellular radio access network according to any one of the radio access technologies indicated in FIG. 1.

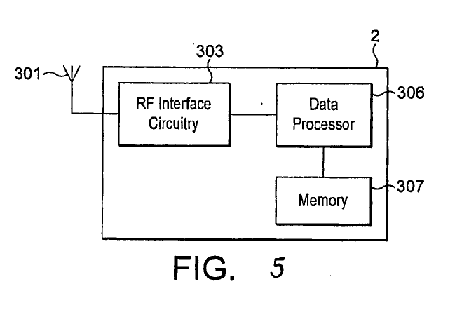

FIG. 4 illustrates an example of the user equipment (UE) shown in FIGS. 1, 2 and 3 in further detail.

FIG. 5 illustrates an apparatus suitable for implementing an embodiment of the invention at an access node or base station of any one of the radio networks shown in FIG. 1;

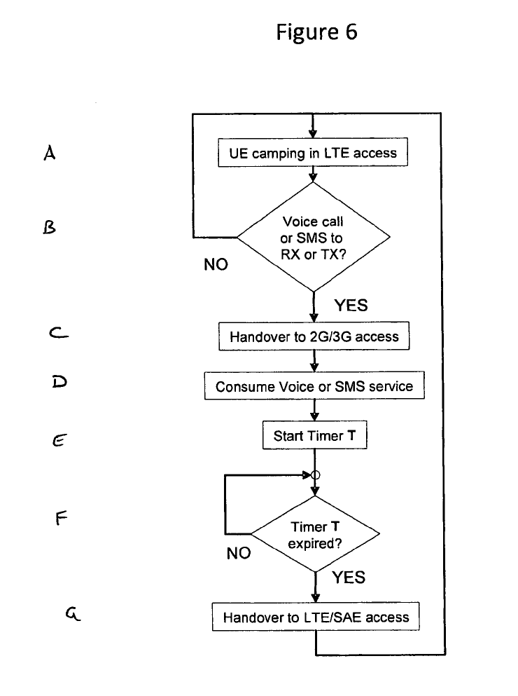

FIG. 6 illustrates an operation of the communication system of FIGS. 1 and 2 in accordance with a method according to an embodiment of the present invention; and

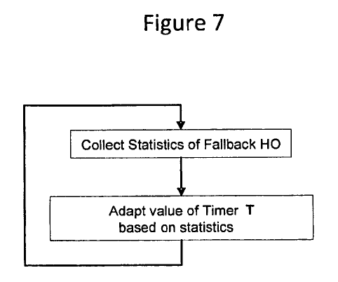

FIG. 7 illustrates another operation of the communication system of FIGS. 1 and 2 in accordance with an embodiment of the present invention.

The communication system of FIG. 1 comprises a user equipment 8, a 2G/3G radio access network 400 via which the user equipment 8 can access a circuit-switched network 410 or a packet-switched network 420, and an LTE/SAE access network 430 via which the UE 8 can access said packet-switched network 420 but not said circuit-switched network 410.

With reference to FIG. 3, each access network 400, 430 comprises a first access node 2 with a first coverage area 101, a second access node 4 with a second coverage area 103 and a third access node 6 with a third coverage area 105. Furthermore FIG. 4 shows user equipment 8 which is configured to communicate with at least one of the access nodes 2, 4, 6. These coverage areas may also be known as cellular coverage areas or cells where the access network is a cellular communications network. For the 2G/3G access network(s) of FIG. 1, the access nodes are referred to as base stations (BS) or NodeBs (NB); and for the LTE/SAE access network(s) of FIG. 1, the access nodes are referred to as eNodeB (eNB) or base stations (BS).

FIG. 4 shows a schematic partially sectioned view of an example of user equipment 8 that may be used for accessing the access nodes and thus the communication system via a wireless interface. The user equipment (UE) 8 may be used for various tasks such as making and receiving phone calls, for receiving and sending data from and to a data network and for experiencing, for example, multimedia or other content.

The UE 8 may be any device capable of at least sending or receiving radio signals. Non-limiting examples include a mobile station (MS), a portable computer provided with a wireless interface card or other wireless interface facility, personal data assistant (PDA) provided with wireless communication capabilities, or any combinations of these or the like. The UE 8 may communicate via an appropriate radio interface arrangement of the UE 8. The interface arrangement may be provided for example by means of a radio part 7 and associated antenna arrangement. The antenna arrangement may be arranged internally or externally to the UE 8.

The UE 8 may be provided with at least one data processing entity 3 and at least one memory or data storage entity 7 for use in tasks it is designed to perform. The data processor 3 and memory 7 may be provided on an appropriate circuit board 9 and/or in chipsets.

The user may control the operation of the UE 8 by means of a suitable user interface such as key pad 1, voice commands, touch sensitive screen or pad, combinations thereof or the like. A display 5, a speaker and a microphone may also be provided. Furthermore, the UE 8 may comprise appropriate connectors (either wired or wireless) to other devices and/or for connecting external accessories, for example hands-free equipment, thereto.

As can be seen with respect to FIG. 3, the UE 8 may be configured to communicate with at least one of a number of access nodes 2, 4, 6, for example when it is located in the coverage area 101 of a first access node 2 the apparatus is configured to be able to communicate to the first access node 2, when in the coverage area 103 of a second node 4 the apparatus may be able to communicate with the second access node 4, and when in the coverage area 105 of the third access node 6 the apparatus may be able to communicate with the third access node 6.

FIG. 5 shows an example of the first access node 2. The access node 2 comprises one or more radio frequency antennas 301 configured to receive and transmit radio frequency signals, radio frequency interface circuitry 303 configured to interface the radio frequency signals received and transmitted by the antenna 301 and the data processor 167. The radio frequency interface circuitry may also be known as a transceiver. The access node 2 may also comprise a data processor configured to process signals from the radio frequency interface circuitry 303, control the radio frequency interface circuitry 303 to generate suitable RF signals to communicate information to the UE 8 via the wireless communications link. The access node further comprises a memory 307 for storing data, parameters and instructions for use by the data processor 305.

It would be appreciated that both the UE 8 and access node 2 shown in FIGS. 4 and 5 respectively and described above may comprise further elements which are not directly involved with the embodiments of the invention described hereafter.

FIG. 2 illustrates in more detail the architecture of the system of FIG. 1. The LTE/SAE network 430 operates according to E-UTRAN technology; and the 2G/3G network(s) 400 operates according to UTRAN and/or GERAN technology.

UE 8 is capable of operation according to both the LTE and 2G/3G radio access technologies indicated in FIGS. 1 and 2. Where LTE access coverage overlaps with 2G/3G access coverage, the UE 8 is mainly served by the LTE network 430 for the uplink and downlink transmission of user plane packet data units (PDUs). However, when connected to the LTE network 430, UE 8 may use a 2G/3G network 400 to connect to the circuit-switched (CS) domain. For example, UE 8 may use the 2G/3G network 400 for sending and/or receiving a voice call or an SMS (Short Message Service) text message.

Handover from the LTE network 430 to the 2G/3G network 400 is initiated by UE 8 for a voice call or SMS message originating at the UE 8, and is initiated by the LTE network for a voice call or SMS message terminating at the UE 8. For the system architecture shown in FIG. 2, a procedure for this CS-Fallback inter-RAT handover is specified in 3GPP TS 23.272 V.9.0.0 (2009-06) and 3GPP 23.401 V9.1.0 (2009-06). A general outline of the procedure is described below for both calls originating at the UE 8 and calls terminating at the UE 8. In the case of a call originating at UE 8, the procedure begins with the UE 8 indicating to the MME 550 via E-UTRAN 530 that the UE 8 should be moved to UTRAN/GERAN 530; the MME 550 indicates to E-UTRAN 530 that the UE 8 should be moved to UTRAN/GERAN 510, 520; and E-UTRAN 530 triggers handover to a GERAN/UTRAN neighbour cell. In the case of a call terminating at UE 8, the procedure begins with the MSC Server 560 receiving an incoming call; the MSC Server 560 sends a CS call indicator to the UE 8 via the MME 550 and E-UTRAN 530; UE 8 sends to MME 550 via E-UTRAN 530 an indication that a CS Fallback from E-UTRAN 530 to UTRAN/GERAN 510, 520 is required; and MME sends an instruction to E-UTRAN to move the UE to UTRAN/GERAN.

Once the voice call- or SMS-triggered fallback handover from the LTE network 430 to the 2G/3G network 400 is completed, a communication session is initiated for the voice call or SMS message. When said communication session is terminated (i.e. when the voice call is terminated (for whatever reason) or when transmission of the SMS message is completed), it is generally desirable to handover UE 8 back to the LTE network 430 from the point of view of improving the quality of service for packet-switched services for UE 8, and relieving load on the 2G/3G network(s) 400.

However, it has been observed that the completion of one CS service is often shortly followed by a demand for another CS service of the same kind. For example, it has been observed that a first voice call to or from a user equipment is often shortly followed by another voice call either because the receiving end did not pick up the first voice call or because the receiving end was engaged/busy. By way of another example, it has been observed that a first SMS message is often shortly followed by a second SMS message in reply to the first SMS message.

According to an embodiment of the present invention, the initiation of a handover back to the LTE network 430 from the 2G/3G network 400 is prevented before the expiry of a predetermined length of time after the end of a CS-service provided via the 2G/3G network 400. With reference to steps D to G of FIG. 6, a timer T is started upon completion of the communication session initiated for the CS service for which handover from the LTE network 430 to the 2G/3G network 400 was effected. Initiation of a handover from the 2G/3G network 400 back to the LTE network 430 occurs at the expiry of the timer T if there has been no initiation of a further communication session for a further CS service in the meantime, i.e. if there is no initiation of a further communication session for a CS-service before the expiry of a predetermined length of time T after the completion of the first communication session for a CS service. For the system shown in FIG. 2, the handover back to E-UTRAN from UTRAN/GERAN proceeds according to the procedure specified in 3GPP TS 23.401 V9.1.0 (2009-06).

In the system architecture illustrated in FIG. 2, the radio network controller (RNC) of the UTRAN network or the base station subsystem (BSS) of the GERAN network initiates the inter-RAT handover back to E-UTRAN; and timer T is located at the 2G/3G network, i.e. and steps E and F of FIG. 6 are carried out at the 2G/3G network. However, for other radio access technologies such as WiMAX and WLAN, it may be the user equipment that initiates a inter-RAT handover back to LTE, and timer T is located at the user equipment; i.e. it is the user equipment that prevents the initiation of a handover back to LTE before the expiry of a predetermined time T after the end of a service provided via the RAT from which handover is made back to LTE.

Depending on the UE or network capability and operator policies, packet-switched services can proceed via the 2G/3G network 400 after or during completion of a CS-service session and before expiry of timer T.

The value of timer T is determined on the basis of statistical information collected about past occurrences of repeated inter-RAT fallback handovers. The statistical information can be limited to information that has been collected locally, and that is limited to information about past occurrences of repeated inter-RAT fallback handovers between the specific radio access networks for which timer T value is to be determined. Alternatively, it can be information that also includes statistical information for inter-RAT handovers between other LTE and 2G/3G network(s) in other locations. In the case of the latter, such statistical information could for example be collected from a plurality of locations by a centralized Operations and Maintenance (O&M) function 440 and then provided to the local 2G/3G network for which timer T is to be determined.

In either case, the value of Timer T can be determined either (a) on the basis of such statistical information for UE 8 only; (b) on the basis of such statistical information for UE 8 and any other user equipment that shares a subscriber ID with UE 8; or (c) on the basis of such statistical information for all user equipments for which information is collected.

For any of the above, the statistical information can be sub-divided according to one or more of the following categories: (i) time-of-day at which handover takes place; (ii) type of location at which handover takes place (e.g. city center, rural areas, suburbs); (iii) user equipment capability; and (iv) traffic consumption type (e.g. voice-only users, low rate users, high rate streaming users). The predetermined time T for UE 8 can be determined on the basis of statistical information for only one or more categories that best match the handover for which timer T is to be determined.

The timer value T is further dynamically optimized based on the continued collection of statistical information. The timer value T is reduced (e.g. by 10%) if the statistical information starts to indicate that the UE 8 or user equipments in general are spending too much time in 2G/3G network(s) when they could be served by a LTE network. On the other hand, the timer value T is increased (e.g. by 50%) if the statistical information starts to indicate that fallback handovers from LTE to 2G/3G are happening too often and thereby imposing an excessive burden on control plane signaling for both LTE and 2G/3G network(s) and causing excessive terminal battery drain.

Maintenance of the value of Timer T at an optimum level can be carried out locally, i.e. at local access network controllers for the 2G/3G network and/or the LTE network. Alternatively, it can be carried out more centrally at an O&M function and then distributed to local access network controllers (e.g. a Base Station Controller (BSC) for a 2G network, and a Radio Network Controller (RNC) for a 3G network).

For the case of local maintenance of the timer value, the maintenance can be carried out by the network which receives handovers for CS services (i.e. the 2G/3G network). Alternatively, the network from which the UE 8 is handed over (i.e. the LTE network) can carry out the maintenance of the timer T value. For the latter alternative, updated information about the optimized timer T value can be imparted from the LTE network 430 to the 2G/3G network(s) 400 either (a) as part of general inter-RAT handover procedure signaling from the LTE network 430 to the 2G/3G network(s) 400, or (b) made part of the UE context transferred in intra-LTE handovers and Idle-Active transition UE context.

Where desired, an upper limit could be set on how long the timer T value can be extended by the above-mentioned optimization processes. For example, an operator of the LTE and/or 3G/2G network(s) could decide an upper limit for the timer T value.

An embodiment of the invention has been described in detail above in relation to the handover from LTE to 2G/3G for the purpose of providing a circuit-switched (CS) service. However, the service for which handover is made from LTE to 2G/3G may, for example, be another service that is not available via LTE, such as access to home or corporate services.

The above-described operations may require data processing in the various entities. The data processing may be provided by means of one or more data processors. Similarly various entities described in the above embodiments may be implemented within a single or a plurality of data processing entities and/or data processors. Appropriately adapted computer program code product may be used for implementing the embodiments, when loaded to a computer. The program code product for providing the operation may be stored on and provided by means of a carrier medium such as a carrier disc, card or tape. A possibility is to download the program code product via a data network. Implementation may be provided with appropriate software in a server.

For example the embodiments of the invention may be implemented as a chipset, in other words a series of integrated circuits communicating among each other. The chipset may comprise microprocessors arranged to run code, application specific integrated circuits (ASICs), or programmable digital signal processors for performing the operations described above.

Embodiments of the invention may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The applicant draws attention to the fact that the present invention may include any feature or combination of features disclosed herein either implicitly or explicitly or any generalisation thereof, without limitation to the scope of any definitions set out above. In addition to the modifications explicitly mentioned above, it will be evident to a person skilled in the art that various other modifications of the described embodiment may be made within the scope of the invention.

1. A method comprising: preventing initiation of a handover of a communication device back to a first radio access technology from a second radio access technology before the expiry of a predetermined length of time after the end of a service provided via the second radio access technology.

2. A method according to claim 1, wherein the predetermined time is determined taking into account information about time gaps between previous handovers from said first access technology to said second handover technology.

3. A method according to claim 2, wherein said information is limited to information for said communication device, or is limited to information for a subscriber with which said communication device is associated.

4. A method according to claim 2, wherein said information includes information for said communication device and other communication devices.

5. A method according to claim 2, wherein said predetermined time is determined further taking into account one or more of the following: (a) the time of the handover from said first access technology to said second access technology; and (b) the type of environment in which the handover from said first access technology to said second access technology takes place.

6. A method according to claim 4, wherein said predetermined time is determined further taking into account one or more of the following: (a) a capability category of said communication device; and (b) a class of traffic consumption history to which said communication device belongs.

7. A method according to claim 1, wherein said service is a circuit-switched service.

8. A method according to claim 1, comprising: initiating the handover of said communication device back to said first radio access technology from said second radio access technology after the expiry of said predetermined length of time.

9. A method according to claim 1, wherein said first radio access technology enables packet-switched services, and said second radio access technology enables both packet-switched services and circuit-switched services.

10. A method according to claim 1, further including receiving an indicator of said predetermined time as part of signalling for a handover from said first access technology to said second access technology prior to said service.

11. An apparatus configured to carry out the method of claim 1.

12. An apparatus comprising: a processor and memory including computer program code, wherein the memory and the computer program code are configured to, with the processor, cause the apparatus at least to perform the method of claim 1.

13. A computer program product comprising program code means which when loaded into a computer controls the computer to perform a method according to claim 1.

14. A method comprising: as part of the signalling for a handover of a communication device from a first radio access technology to a second radio access technology, providing from an element associated with the first radio access technology to an element associated with the second radio access technology an indicator of a predetermined time after the end of a service provided via said second radio access technology before which handover of said communication device back to the first radio access technology is to be prevented.

15. An apparatus configured to carry out the method of claim 14.

16. An apparatus comprising: a processor and memory including computer program code, wherein the memory and the computer program code are configured to, with the processor, cause the apparatus at least to perform the method of claim 14.

17. A computer program product comprising program code means which when loaded into a computer controls the computer to perform a method according to claim 14.

18. A method comprising: handing over a communication device from a first radio access technology to a second radio access technology; providing a service to the communication device via the second radio access technology; and preventing initiation of a handover of said communication device back to said first radio access technology from said second radio access technology before the expiry of a predetermined length of time after the end of a service provided via the second radio access technology.

19. A system configured to: hand over a communication device from a first radio access technology to a second radio access technology; provide a service to the communication device via the second radio access technology; and prevent initiation of a handover of said communication device back to said first radio access technology from said second radio access technology before the expiry of a predetermined length of time after the end of a service provided via the second radio access technology.
